(19) United States
(12) Patent Application Publication
(10) Pub. No.: US 2016/0134071 A1
(43) Pub. Date: May 12, 2016

(54) ELECTRICAL CONNECTOR WITH ROTATABLE PRONGS

(71) Applicant: Volex plc, London (GB)

(72) Inventors: Mui Lian Jessica Toh, Singapore (SG); Yuan Wen Mo, Singapore (SG)

(21) Appl. No.: 14/536,515

(22) Filed: Nov. 7, 2014

(51) Int. Cl. H01R 35/04; H01R 13/60

(52) U.S. Cl. CPC H01R 35/04; H01R 13/60

(57) ABSTRACT

An electrical connector that includes a connector for connecting to a power adapter or directly connecting to an electrical device, and an electrical plug for connecting to a main supply. The electrical plug can move between a storage position, a first working position, and a second working position. The electrical plug may have a mechanism that fixes the prongs of the plug in one of these positions unless greater than a threshold amount of force is exerted on the prongs in a particular direction. In the storage position, the electrical plug may be inaccessible to an electrical outlet and electrically disconnected from the terminals of the connector. The first working position, second working position, and storage position may all be substantially perpendicular to each other. The plug may be moved from the second working position to the storage position by passing through the first working position.

### TECHNICAL FIELD

The present disclosure relates to an electrical connector, and more particularly to an electrical connector including prongs which can rotate between multiple working positions and a storage position.

### BACKGROUND

Electronic devices, and specifically portable electronic devices such as mobile phones, personal digital assistants (PDAs), digital still cameras, digital video cameras, notebook computers, and the like, have built-in batteries. If no external power supply apparatus is provided to power the portable electronic device, the built-in battery is usually used as the main power source. If the power supplied from the battery is insufficient, the user may simply plug into the electrical device an electrical connector of a power supply apparatus, such as a power adapter, to provide power for operating the electronic device and for charging the battery. With the proliferation of electronic devices, outlet space is at a premium in many homes and businesses. An electrical connector that can be used in multiple configurations is desirable because it would allow people to choose the configuration that best optimizes the space and outlets available to them. Similarly, the storage position can be used while the connector is being transported, such as between home and an office, to prevent damage to the connector as well as other items a person may be carrying.

### SUMMARY

An electrical connector according to embodiments of the present application comprises a connector for connecting to a power adapter or directly connecting to an electrical device, and an electrical plug for connecting to a main supply; the connector includes a line terminal and a neutral terminal. The electrical plug includes a housing comprising a housing cover and a housing base, a line prong, and a neutral prong. Both the line prong and neutral prong may be capable of rotating between multiple working positions and a storage position, while remaining electrically connected to their respective terminals. The system of the present application further comprises a cam configured to maintain the working positions.

An electrical plug according to embodiments of the present application comprises a prong bridge connecting the line prong to the neutral prong a line prong, and capable of rotating together between multiple working positions and a storage position. The prong bridge also comprises of a cam capable of coaxially rotating with the prong bridge. The prongs are inaccessible to an electrical outlet, and electrically disconnected from the terminals-when in a storage position.

When the prongs are in the first working position, they may be substantially perpendicular to the terminals. When the prongs are in the second working position, they may be substantially parallel with the terminals. When the prongs are in the storage position, they may be substantially perpendicular to the terminals and the position of the prongs when the prongs are in the first or second working positions.

An electrical connector according to the present application is safe and convenient to the user. A line prong and a neutral prong may easily and smoothly rotate between the working positions and the storage position.

### BRIEF DESCRIPTION OF THE DRAWINGS

FIG. 1 is an exploded view of an electrical connector with rotatable prongs and a portion of an associated electrical device that the electrical connector may detach from;

FIGS. 2A, 2B and 2C illustrate the assembled electrical connector of FIG. 1 with prongs displayed in a first working position, a second working position, and a storage position;

FIGS. 3A and 3B illustrate the electrical connector with and without housing as the prongs illustrated in FIGS. 2A and 2B are rotated from a first working position to a second working position;

FIGS. 4A, 4B and 4C illustrate the operation of the cam of the electrical connector when the prongs are rotated from a first working position to a second working position;

FIGS. 5A and 5B illustrate the electrical connector with and without housing as the prongs illustrated in FIGS. 2A and 2C are rotated from a first working position to a storage position;

FIG. 6 illustrates a detailed view of the stopper assembly that holds the prongs of the electrical connector in a first working position; and

FIGS. 7A and 7B illustrate the path of current flow through the electrical connector when in operation.

### DETAILED DESCRIPTION OF ILLUSTRATIVE EMBODIMENTS

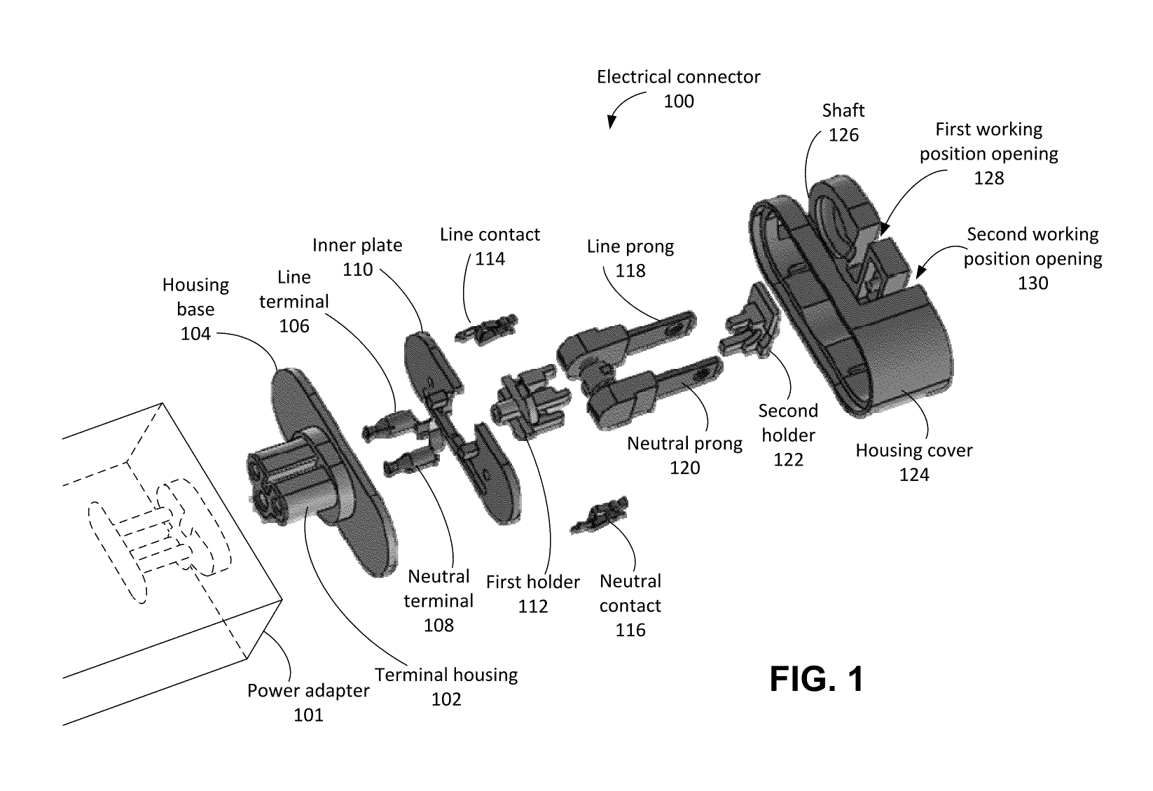

FIG. 1 illustrates an exploded view of an electrical connector 100 and a partial view of a power adapter 101 into which the electrical connector 100 may be placed. The electrical connector 100 comprises terminal housing 102 and prongs made up of line (hot) prong 118 and neutral prong 120. Terminal housing 102 is configured to connect to an inlet of an electrical power adapter 101, so that electrical connector 100 may be connected to the power adapter.

The power adapter 101 operates as a power supply, which may or may not include a transformer or other means of converting different voltages and currents of the AC power to DC power. In the present illustration, if terminal housing 102, is a C5 connector, then the inlet of the electrical adapter would be a C6 inlet. In addition, if an electrical device does not make use of an adapter, and the electrical device itself includes an appropriate inlet (such as a C6 inlet), then the electrical connector 100 could be connected directly to the electrical device.

The electrical connector as disclosed herein can use plugs of any voltage standard and plugs supporting two or more voltage standards. The electrical connector can also use plugs of any shape, size, and type. For example, FIGS. 1-7 illustrate an electrical connector 100 with a type A plug used in North America. As noted, alternative embodiments can be used with any other suitable plugs that include a line prong 118 and a neutral prong 120.

The electrical connector 100 further includes a housing base 104, a line terminal 106, a neutral terminal 108, an inner plate 110, a first holder 112, a line contact 114, a neutral contact 116, a second holder 122, a housing cover 124, and a recess 126. The housing cover 124 and the housing base 104 may be of a suitable insulation material, such as plastic. The housing cover 124 and the housing base 104 may be connected to each other to form a housing for supporting and receiving prongs 118 and 120, and other components. First holder 112, second holder 122, and inner plate 110 may also be of a suitable insulation material, such as plastic. Line prong 118, neutral prong 120, line contact 114, neutral contact 116, line terminal 106, and a neutral terminal 108 may be made of an electrically conductive material, such as copper or brass. Line prong 118 may be electrically coupled to line contact 114, which may be electrically coupled to line terminal 106. Likewise, neutral prong 120 may be electrically coupled to neutral contact 116, which may be electrically coupled to neutral terminal 108. Line terminal 106 and neutral terminal 108 may be fixed in terminal housing 102.

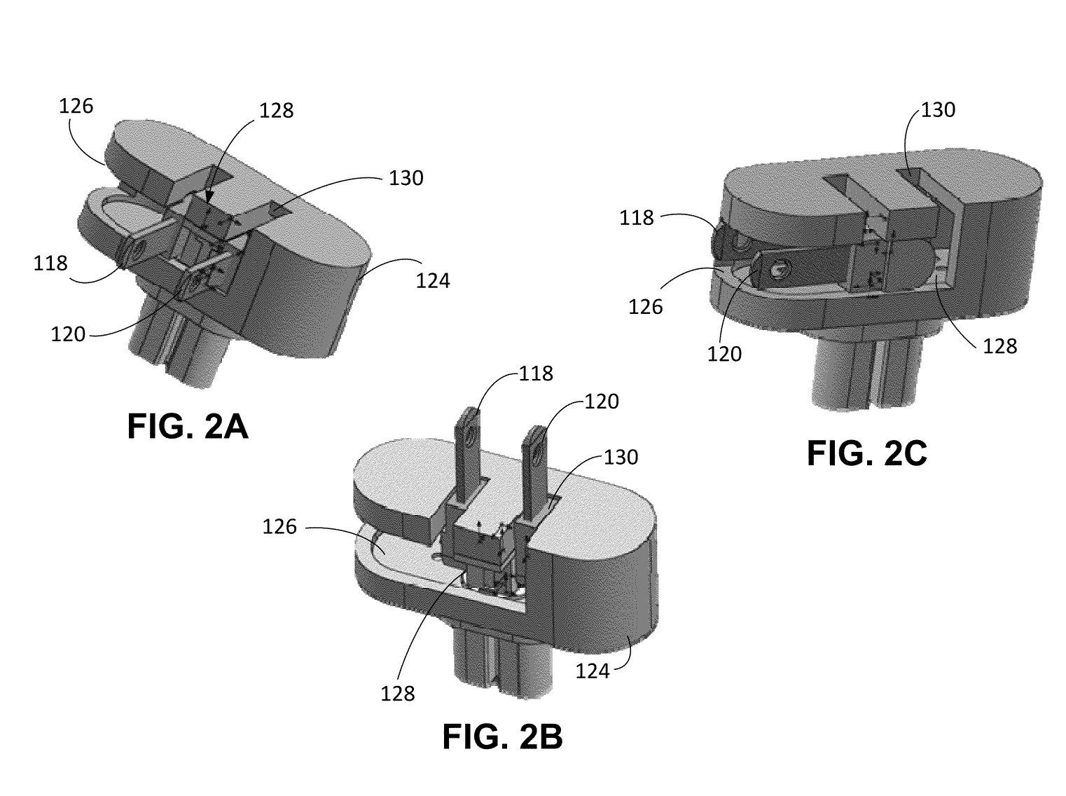

Line prong 118 and neutral prong 120 may rotate between a storage position within recess 126, a first working position at first working position opening 128, and a second working position at second working position opening 130. Further detail of these three positions is shown in FIGS. 2A-2C.

FIG. 2A depicts line prong 118 and neutral prong 120 in a first working position in first working position opening 128. As depicted, the prongs may be rotated 90 degrees toward the left of the figure to move into the storage position within recess 126. As depicted, the prongs may also be rotated 90 degrees toward the top of the figure to move into the second working position at second working position opening 130. While in the first working position of first working position opening 128, the prongs may be connected to a power supply, such as a wall socket.

FIG. 2B depicts line prong 118 and neutral prong 120 in a second working position in second working position opening 130. As depicted, the prongs may be rotated 90 degrees toward the bottom of the figure to move into the first working position opening 128. As depicted, the prongs may not move into the storage position at recess 126 without first passing through the first working position. It may be appreciated that there are embodiments where the prongs may move into the storage position at shaft 126 without first passing through the first working position. While in the second working position of second working position opening 130, the prongs may be connected to a power supply, such as a wall socket.

FIG. 2C depicts line prong 118 and neutral prong 120 in a storage position in recess 126. As depicted, the prongs may be rotated 90 degrees toward the right of the figure to move into the first working position opening 128. As depicted, the prongs may not move into the second working position opening 130 without first passing through the first working position opening 128. It may be appreciated that there are embodiments where the prongs may move into the second working position opening 130 without first passing through the first working position. While in a storage position in recess 126, the prongs are inaccessible to an electrical outlet and may be electrically disconnected from the terminals.

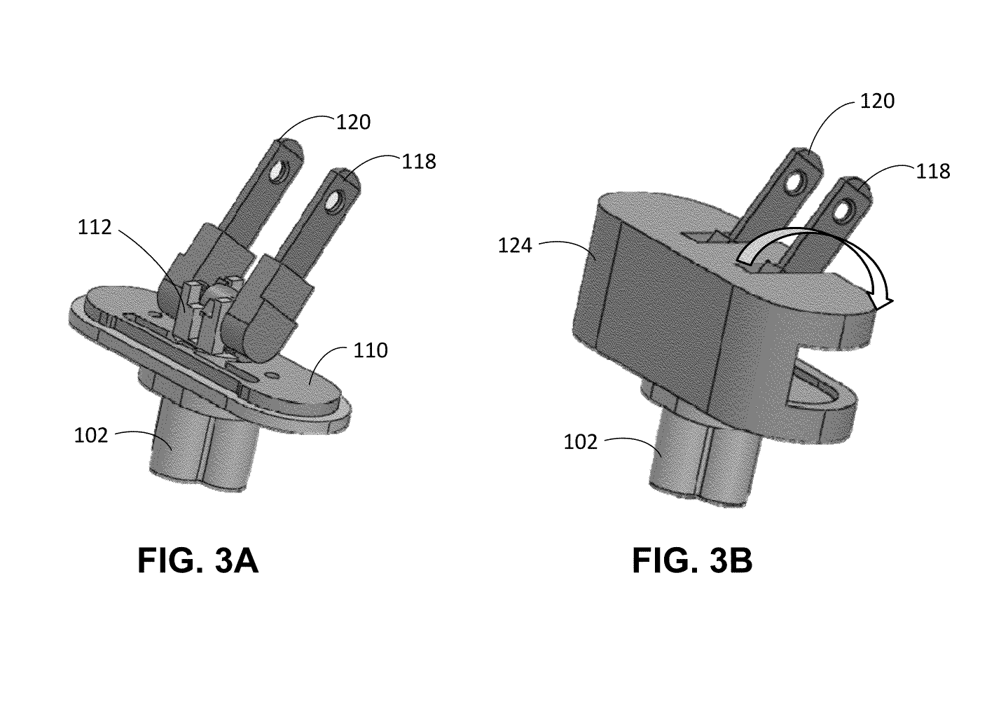

FIGS. 3A and 3B depict further detail of how the prongs 118 and 120 may rotate. As depicted in FIG. 3A, prongs 118 and 120 are connected by a prong bridge to first holder 112, and may rotate coaxially to be parallel or perpendicular to the terminals. FIG. 3B shows how prongs 118 and 120 may operate when housing cover 124 has been placed over first holder 112.

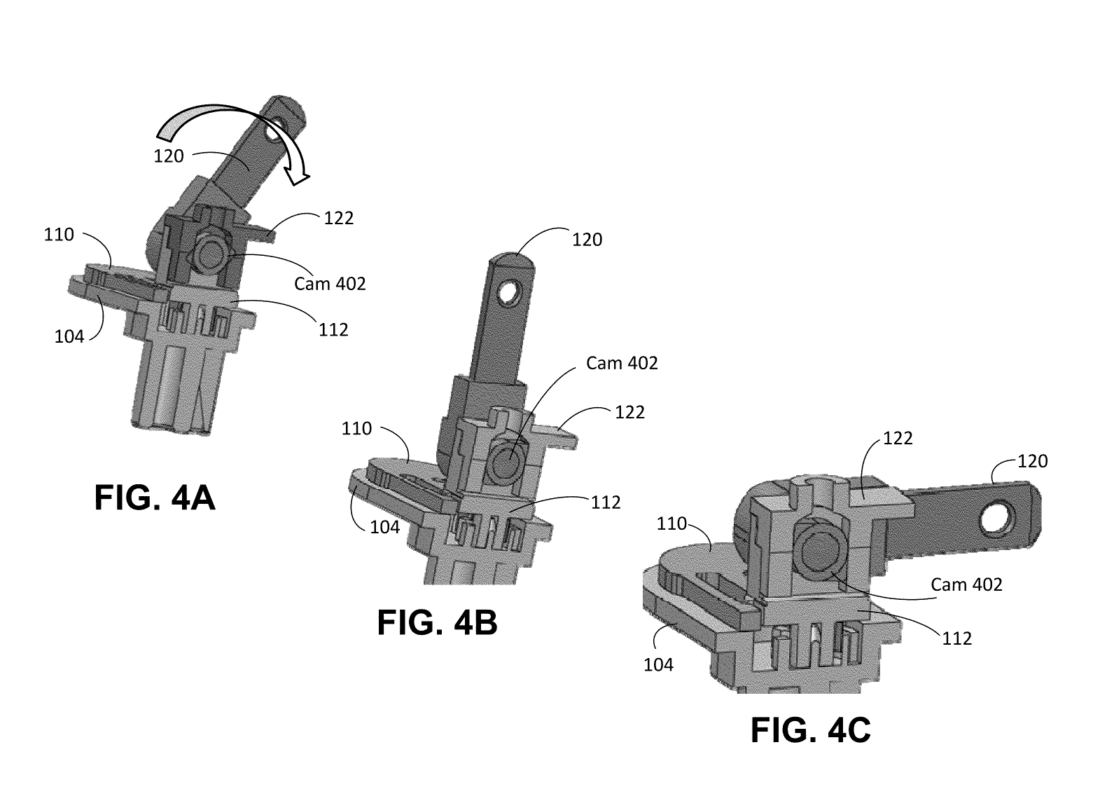

FIGS. 4A, 4B, and 4C depict cross-sectional views of the electrical connector in FIG. 4A that illustrate aspects of how a prong may be fixed in the first or second working positions. Cam 402 rotates with neutral prong 120; the two are connected by a prong bridge. As depicted in FIG. 4A, cam 402 distort the shape of second holder 122 when rotated. Then, as depicted in FIG. 4B, where neutral prong 120 is rotated into the second working position, cam 402 is positioned to maintain the position of, or resist movement, of neutral prong 120 when minor forces act upon neutral prong 120. When greater forces toward the first working position act upon neutral prong 120, cam 402 will distort second holder 122, and neutral prong 120 will rotate toward the first working position.

FIG. 4C then shows neutral prong 120 in the first working position. Cam 402 is positioned to maintain the position of, or resist movement of, neutral prong 120 when minor forces act upon neutral prong 120. When greater forces toward the second working position act upon neutral prong 120, cam 402 will distort second holder 122, and neutral prong 120 will rotate toward the second working position. It may be noted that neutral prong 120 and first holder 112 may be rotated toward the storage position without affecting the position of cam 402 relative to second holder 122.

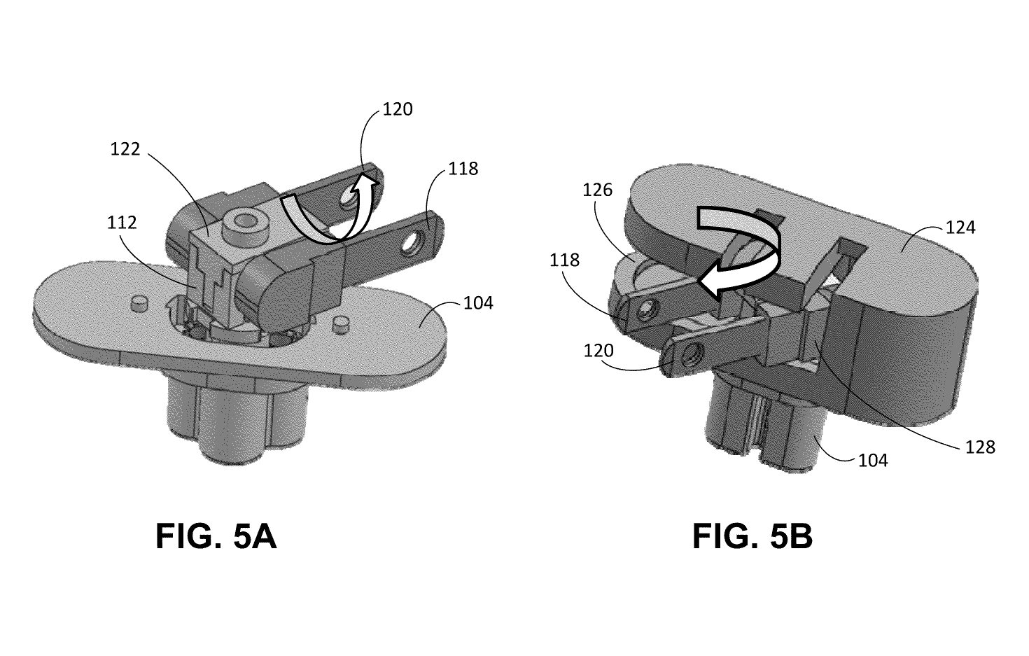

FIGS. 5A and 5B illustrate aspects of how prongs of an electrical connector may rotate along a shaft. First holder 112 and second holder 122 form a housing for prongs 118 and 120, where the housing may rotate relative to housing base 104. FIG. 5A depicts how this housing may rotate relative to housing base 104 with housing cover 124 omitted for clarity, and FIG. 5B depicts how this housing may rotate relative to housing base 104 with housing cover 124 included.

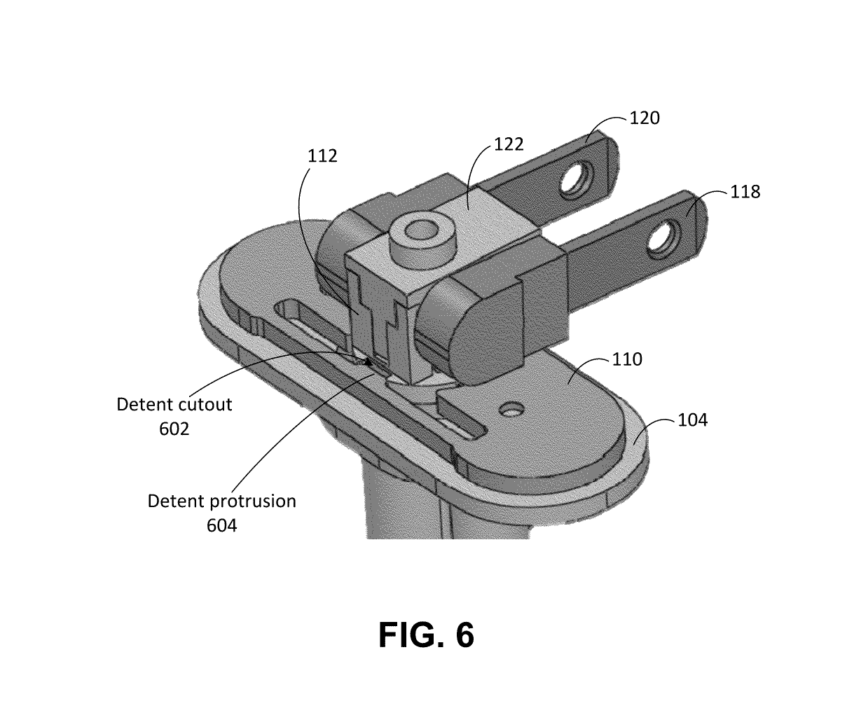

FIG. 6 illustrates aspects of a stopper that may hold rotatable prongs of an electrical connector in a working position. As prongs 118 and 120 rotate parallel to inner plate 110, as depicted in FIGS. 5A-5B, there may be a detent feature to hold, or maintain, prongs 118 and 120 in the first working position. As depicted, first holder 112 has a detent cutout 602 in its shape, and inner plate 110 has a corresponding detent protrusion 604. When the housing formed by first holder 112 and second holder 122 rotates relative to inner plate 110 (with prongs 118 and 120 rotating along with the housing), when prongs 118 and 120 reach the first working position, the detent cutout 602 of first holder 112 meets the detent protrusion 604 of inner plate 110, which fixes prongs 118 and 120 in the first working position (or the second working position, if prongs 118 and 120 are then rotated relative toward the housing and toward the second working position). Upon application of sufficient force toward the storage position, detent cutout 602 will disconnect from detent protrusion 604 and move toward the storage position.

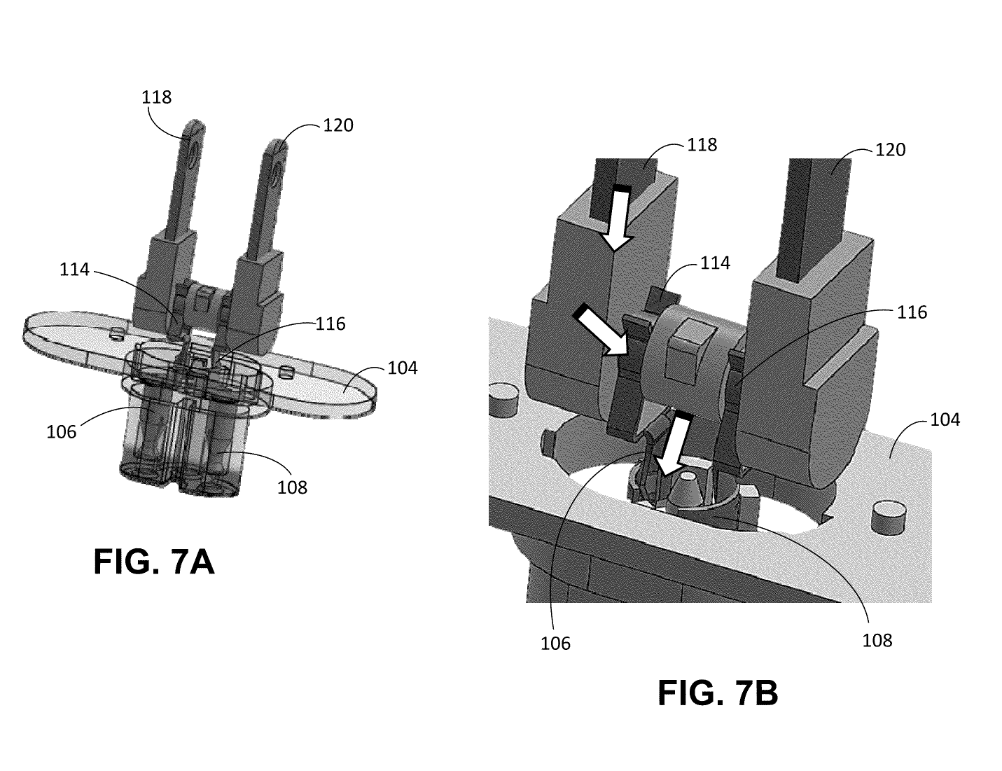

FIGS. 7A and 7B illustrate aspects of power transmission in an electrical connector. As depicted in previous figures, the prongs may be used to transmit electricity when in the first or second working positions. As depicted in FIGS. 7A and 7B, the prongs are in the second working position, though it may be appreciated that a similar description applies to how electricity is transmitted when the prongs are in the first working position. In a closed circuit that includes the following elements, neutral prong 120 is electrically connected to neutral contact 116, which in turn is electrically connected to neutral terminal 108. Likewise, line prong 118 is electrically connected to line contact 114, which in turn is electrically connected to line terminal 106. Neutral contact 116 forms a brushing connection with neutral prong 120 and neutral terminal 108, and line contact 114 forms a brushing connection with line prong 118 and line terminal 106.

FIG. 7B shows a closer view of FIG. 7A. As can be seen more clearly in FIG. 7B, the portions of line terminal 106 and neutral terminal 108 that connect with line terminal 114 and neutral terminal 116 do not connect with each other. When prongs 118 and 120 are rotated into the storage position, the electrical connections between terminals 106 and 108 and contacts 114 and 116 may be broken. So, when the prongs are in the storage position, not only are they in a location where the housing cover 124 prevents them from being plugged into an outlet, but the electrical connections between the terminals and the contacts are also broken.

In addition to the embodiments discussed above, it may be appreciated that there are various alterations, modifications, and improvements. For instance, the specific choice of materials with respect to the various components are within the ability of those skilled in the art according to the application, based on the functional indications given above. The specification and drawings are, accordingly, to be regarded in an illustrative rather than a restrictive sense. It will, however, be evident that various modifications and changes may be made thereunto without departing from the broader spirit and scope of the invention.

What is claimed:

1. An electrical connector system, comprising:
a connector having a housing for connecting to an electrical device or power adapter of an electrical device, the connector comprising a terminal extending from the housing, the terminal including a line terminal, and a neutral terminal; and
prongs mounted within the housing comprising a line prong that connects to the line terminal, and a neutral prong that connects to the neutral terminal, the prongs being configured to move between a storage position, a first working position, and a second working position.

2. The system of claim 1, wherein the prongs are configured to move between the storage position and the second working position by passing through the first working position.

3. The system of claim 1, wherein the prongs are configured to rotate between the storage position and the first working position, and between the first working position and the second working position.

4. The system of claim 1, wherein the housing includes a housing cover and a housing base, the terminals extending from the housing base, the housing cover covering the prongs when in the storage position.

5. The system of claim 1, wherein the line prong is connected to the neutral prong by a prong bridge.

6. The system of claim 5, wherein the prong bridge is coaxially coupled to the prongs such that they are capable of rotating coaxially.

7. The system of claim 6, further comprising:
a cam being fixed to the prong bridge.

8. The system of claim 7, wherein the cam is configured to maintain the first working position and the second working position.

9. The system of claim 1, further comprising:
a holder comprising an insulating material that connects the prongs with the connector.

10. The system of claim 9, wherein the holder is configured to move the prongs between the storage position and the first working position.

11. The system of claim 10, wherein the holder comprises a detent cutout, and further comprising:
an inner plate comprising a detent feature, the detent protrusion and the detent cutout meeting when the prongs are in the first working position.

12. The system of claim 11, wherein the detent cutout and the detent protrusion are configured to maintain the first working position.

13. The system of claim 1, wherein the storage position comprises a location of the prongs relative to a housing where the prongs are inaccessible to an electrical outlet.

14. The system of claim 1, wherein the prongs are electrically disconnected from the terminals when the prongs are in the storage position.

15. The system of claim 1, further comprising:
contacts comprising a line contact and a neutral contact comprising an electrically conductive material that are capable of being electrically connected with the terminals and the prongs when the prongs are in the first or second working positions.

16. The system of claim 15, wherein the contacts are in brushing contact with the prongs.

17. The system of claim 15, wherein the contacts are in brushing contact with the terminals when the prongs are in the first or second working positions.

18. The system of claim 1, wherein the prongs are substantially perpendicular to the terminals when the prongs are in the first working position.

19. The system of claim 1, wherein the prongs are substantially parallel to the terminals when the prongs are in the second working position.

20. The system of claim 1, wherein the prongs are substantially perpendicular to the terminals when the prongs are in the storage position.
